(19) United States
(12) Patent Application Publication
(10) Pub. No.: US 2015/0323661 A1
(43) Pub. Date: Nov. 12, 2015

(54) METHOD AND DEVICE FOR MONITORING AN IMMOBILE SPACE REGION

(71) Applicant: Robert Bosch GmbH, Stuttgart (DE)

(72) Inventor: Frank LUEDER, Untergruppenbach (DE)

(21) Appl. No.: 14/703,252

(22) Filed: May 4, 2015

(30) Foreign Application Priority Data
May 6, 2014 (DE) 10 2014 208 386.9

(51) Int. Cl. G01S 13/62; G01S 13/88; G01S 7/41; G01S 13/42

(52) U.S. Cl. CPC G01S 13/62; G01S 13/42; G01S 13/88; G01S 7/41; G01S 2007/027

(57) ABSTRACT

A device for monitoring an immobile space region includes: a radar transmitting device fixedly installed with respect to the immobile space region and configured for emitting radar beams; a radar receiving device fixedly installed with respect to the immobile space region and configured for receiving the emitted radar beams reflected at an object in the immobile space region; an evaluation device for evaluating the received radar beams using a predetermined evaluation model for determining a position and/or a trajectory of the object in the immobile space region; a control unit for generating a control signal based on a predetermined decision model as well as based on the determined position and/or the determined trajectory of the object; and an actuator device controlled using the control signals generated by the control unit.

### BACKGROUND OF THE INVENTION

1. Field of the Invention

The present invention relates to a method and a device for monitoring an immobile space region, i.e., an area or a volume which is fixed relatively to the ground, e.g., a piece of real estate or a part thereof, a section of an air space, a section of a tunnel, or the like, for which the geographic position does not change.

2. Description of the Related Art

Conventional monitoring systems for monitoring a space region will normally use optical sensors such as video cameras or infrared sensors in order to detect objects penetrating the space region that is to be monitored, such as persons. These monitoring systems frequently require great personal effort, for instance, for sighting and evaluating the image data and/or the sonic data produced, or they supply results which allow for considerable leeway for misinterpretations.

Furthermore, conventional monitoring systems frequently do not enable one to classify the penetrating objects according to their relevance.

Published European application document EP 2 645 570 A1 describes an optical motion sensor. The optical motion sensor has a photodiode and a voltage standardization device connected in series to the latter. Thereby, the operability of the motion sensor is to be maintained both at bright and at dark illumination situations.

In the field of vehicle technology, radar devices are known for vehicles by which trajectories of objects in street traffic are able to be recorded and able to be transmitted for further analysis to evaluation devices. These radar devices are usually greatly adapted to the vehicle in which they are installed. The zone to be monitored keeps on moving with the vehicle.

### BRIEF SUMMARY OF THE INVENTION

Accordingly, there is provided: a method for monitoring an immobile space region, having the steps: Emitting radar beams using a radar transmitting device that is fixedly installed with respect to the immobile space region in the immobile space region; receiving the emitted radar beams, reflected at an object in the immobile space region, using a radar receiving device that is fixedly installed with respect to the immobile space region; evaluating the received radar beams using an evaluation device while using a predetermined evaluation model for determining a first position and/or a trajectory of the object in the space region; generating, using a control device, a control signal based on a predetermined decision model as well as based on the determined first position and/or the determined trajectory of the object; and actuating an actuator unit of the device using the generated control signal.

By a device “fixedly installed with respect to the immobile space region” one should understand particularly such a device whose geographic position does not change with its use as intended. For this purpose, such a device may be installed, for example, on a building such as a house, or a bridge, on a lamppost, on or in the ground, on a fence, etc.

The trajectory includes at least information on a current position of the object as well as at least one position of the object in the past, for instance, a location curve of the object that is parameterized in time. Furthermore, the trajectory may include velocity vectors, acceleration vectors and/or higher derivatives of the location curve. Based on the determined location curve of the object, an extrapolation of the location curve into the future may be carried out, based on the evaluation model, for instance, for one or more seconds. The determined trajectory may also include the extrapolation of the location curve into the future. The decision model may include decision rules which are based at least partially on the extrapolation of the location curve of the trajectory.

A device is further provided for monitoring an immobile space region having: a fixedly installed radar sending device for emitting radar beams into the immobile space region; a fixedly installed radar receiving device for receiving the emitted radar beams reflected at an object in the immobile space region; an evaluation device for evaluating the received radar beams while using a predetermined evaluation model for determining a first position and/or a trajectory of the object in the immobile space region; a control unit for generating a control signal based on a predetermined decision model as well as based on the determined first position and/or the determined trajectory of the object; and an actuator unit, which is able to be controlled using the control signals generated by the control unit.

The knowledge on which the present invention is based is that radar beams are able to be used for monitoring a space region.

The idea on which the present invention is now based on taking this knowledge into account, and to provide a method and a device, for monitoring a space, which utilize the advantages of radar devices. In particular, by determining the position and/or the trajectory of the object, while using the predetermined decision model, a classification may be carried out, based on which the control signal is generated or is not generated. For example, the control signal may be generated in case a classification of the object takes place in such a way that the object is an intruder with a probability exceeding a predetermined threshold, perhaps a burglar or a potential thief.

Because of the generation of the control signal only under certain assumptions, the device according to the present invention is able to be particularly energy-saving. This may be especially advantageous if the device is supplied with electric power using an energy store such as a battery.

In the decision model, external variables, which may be supplied to the device according to the present invention via an interface, are taken into account for the generation of the control signal. The control signal may, for instance, be generated only if a user of the device has activated an alarm mode.

According to one preferred refinement, the predetermined evaluation model and/or the predetermined decision model includes information on a second position of a structure with reference to the radar receiving device. Furthermore, during the evaluation, a first relative motion of the object may be determined relative to the structure, based on the items of information. The control signal may further be generated based on the determined first relative motion of the object, relative to the structure. Consequently, a precise classification of the object is able to take place for the improved monitoring of the space region.

According to a further preferred refinement, during the evaluation a second relative motion of the object is also determined relative to the radar receiving device. The control signal may further be generated based on the determined second relative motion of the object, relative to the radar receiving device. Consequently, an even more precise classification of the object is able to take place for the improved monitoring of the space region.

According to one further preferred refinement, during the evaluation of the received radar beams, one may also determine the length of stay of the object in the space region; the generating of the control signal being done further based on the determined length of stay of the object. Consequently, an even more precise classification of the object is able to take place for the improved monitoring of the space region. The control signal may, for instance, be generated only upon a length of stay of the object in the space region that is in excess of a non-vanishing, predetermined minimum length of stay value. The minimum length of stay value may be a few seconds or minutes, for example, and may, in particular, be determined according to how long a possible burglar would require to open a door or a window, in all probability, in the space region. Consequently, an even more precise classification of the object is able to take place for the improved monitoring of the space region.

According to one preferred refinement, the predetermined evaluation model and/or the predetermined decision model of the device, according to the present invention, includes information on a second position of a structure with reference to the radar receiving device. The device may be installed on the structure. Alternatively, the structure may also be spatially and physically separate from the device. The device may be installed on a little summer house in the garden, for example, while a neighboring residential building is defined as the structure.

The evaluation device may furthermore be developed to determine a first relative motion of the object to the structure, based on the information; the control device being further developed to generate the control signal based on the determined first relative motion of the object relative to the structure.

According to a further preferred refinement, the evaluation device is further developed to determine a second relative motion of the object relative to the radar receiving device. Furthermore, the control unit may be developed to generate the control signal based on the determined second relative motion of the object, relative to the radar receiving device.

According to one further preferred refinement, the evaluation device is further developed to determine a length of stay of the object in the immobile space region. Furthermore, the control unit may be developed to generate the control signal based on the determined length of stay of the object in the space region.

According to one further preferred refinement, the device according to the present invention includes a housing; at least the radar sending device, the radar receiving device, the evaluation device and the control unit being situated within the housing; and the housing being fixedly installed on a structure, especially a building, with reference to the immobile space region. The structure, particularly the housing, borders on the immobile space region or is located in the space region.

According to one further preferred refinement, the device according to the present invention also has an interface, using which the evaluation model of the evaluation device and/or the decision model is adaptable to the control unit. Consequently, the device is adaptable to a plurality of individual situations, depending on where the radar receiving device is fixedly installed.

### BRIEF DESCRIPTION OF THE DRAWINGS

FIG. 1 a schematic flow chart to explain a method of monitoring a space region, according to a first specific embodiment of the present invention.

FIG. 2a schematic top view of a street scene to explain the method according to the first specific embodiment.

FIG. 3 a schematic block diagram of a device for monitoring a space region according to a second specific embodiment of the present invention.

### DETAILED DESCRIPTION OF THE INVENTION

Unless indicated otherwise, identical or functionally equivalent elements and devices have been provided with the same reference symbols.

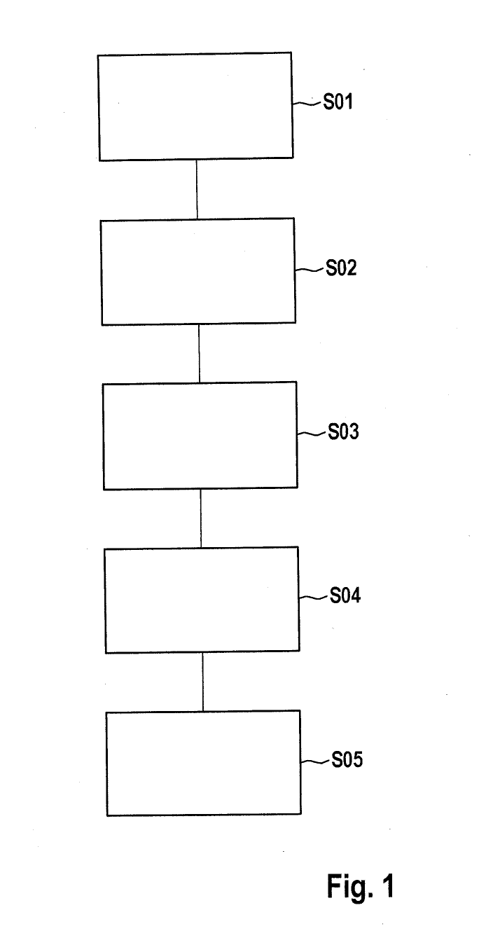

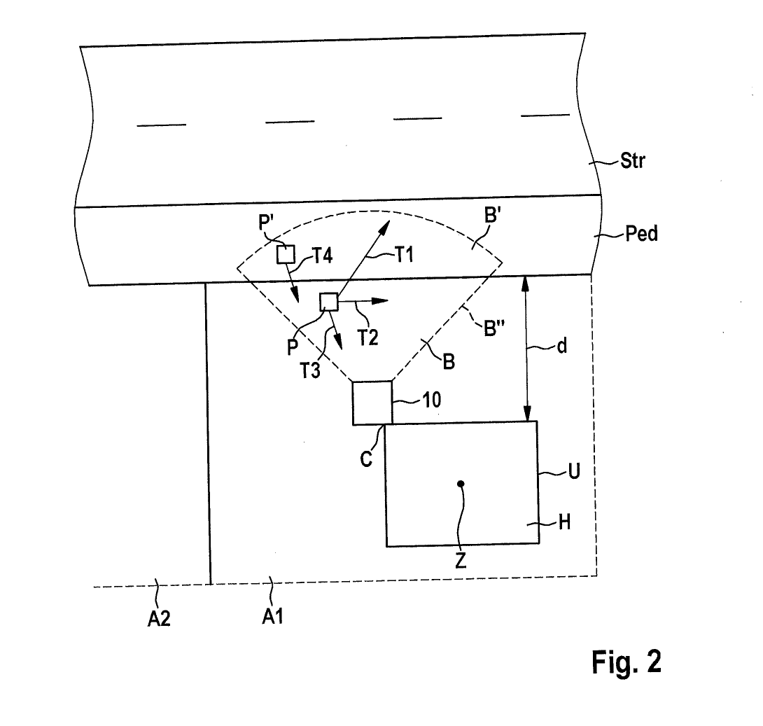

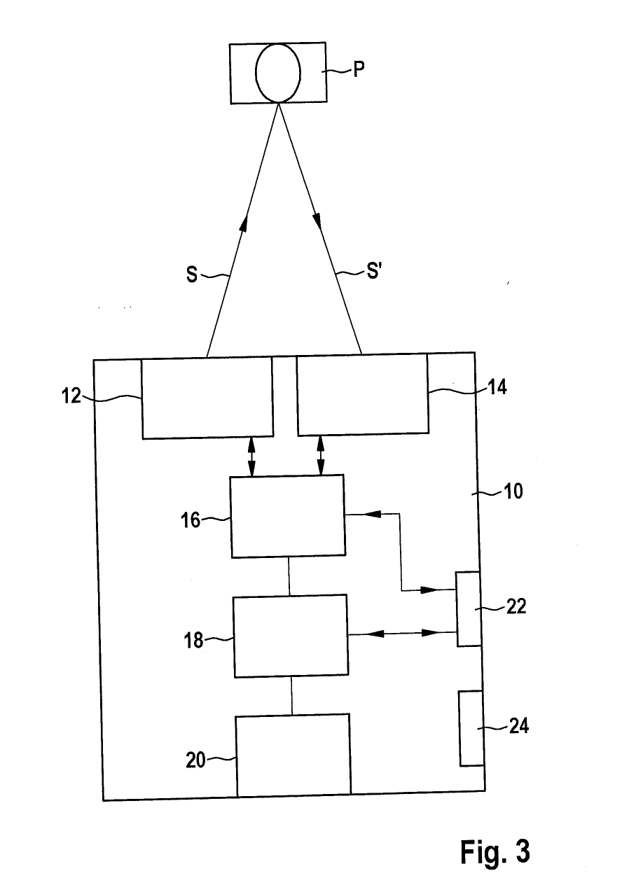

FIG. 1 shows a schematic flow chart to explain a method of monitoring a space region B; B″, according to a first specific embodiment of the present invention. During a description of FIG. 1, reference is also made to reference symbols and representations in FIGS. 2 and 3.

FIG. 2 shows a schematic top view of a street scene to explain the method according to the first specific embodiment.

FIG. 2 shows a street Str having a sidewalk Ped, running in parallel. Two mutually adjacent properties A1, A2 border on the sidewalk. At a distance d from the sidewalk, there is a building H on property A1. At building H, at a corner C of building H, there is mounted a device, according to the present invention, for monitoring space region B according to a second specific embodiment of the present invention.

Using a radar sending device 12, see also FIG. 3, of device 10, radar beams S are able to be emitted into an effective space region B″. Effective space region B″ may particularly be defined in that emitted radar beams S outside of space region B″ have fallen below a predetermined threshold value with regard to their radiant power. The predetermined threshold value may be determined in such a way that radar beams S no longer make possible an evaluation having a desired precision, with their radiant power value below the threshold value.

In a step S01, radar beams S are emitted using a fixedly installed radar sending device 12.

In a step S02, emitted radar beams S′, reflected at an object, such as a person P, in space region B″, are received, using a fixedly installed radar receiving device 14, for this, see also FIG. 3. Radar sending device 12 and radar receiving device 14 may be identical and/or integrated into an in-common housing. In particular, such radar antenna devices may be used as radar sending device 12 and/or as radar receiving device 14, which is usual for radar devices of vehicles. Radar sending device 12 and/or radar receiving device 14 may include an array of antenna elements. A beam direction of radar sending device 12 may be able to be swiveled by mechanical swiveling of radar sending device 12 and/or by electronic beam swiveling, perhaps using a phased array antenna.

In a step S03, received radar beams S′ are evaluated using an evaluation device 16, while using a predetermined evaluation model for determining a first position and/or a trajectory of object P in space region B″. This may take place, for instance, using an evaluation device 16 of device 10 according to the present invention, see FIG. 3.

In an exemplary manner, FIG. 2 shows, for arbitrary objects, a first person P and a second person P′. In an exemplary fashion, a first trajectory T1, a second trajectory T2 and a third trajectory T3 of first person P are shown, to explain the method according to the present invention for monitoring space region B″. In this context, it should be understood that, in the actual case, a person P, P′ has respectively only one trajectory T1, T2, T3 according to his motion within space region B″. Furthermore, FIG. 2 shows a fourth trajectory T4 of second person P′. Instead of a person P, P′, the object may also be an animal, for example, a vehicle, a stone, a story of a building or the like.

According to the first specific embodiment of the method according to the present invention, the predetermined evaluation model has items of information on a position of building H with respect to radar receiving device 14. In evaluation S03, a relative motion of first and second person P, P′ relative to building H is determined based on the items of information in the evaluation model. Again, with reference to FIG. 2, it may thus be determined that first trajectory T1 includes a relative motion of person P relative to building H. Furthermore, it may be determined that third trajectory T3 includes a relative motion towards building H. For this purpose, a geographic center Z of building H may be stored in each case in the evaluation model. Starting from center Z, a distance of object P, P′ may be determined, based on which one is able to determine whether person P, P′ is moving towards building H or away from building H.

Alternatively, an outline U of building H may also be stored in the evaluation model, for example. Based on outline U of building H, a distance of first and second person P, P′ may be specified as a minimum distance from any location desired of outline U, especially as a perpendicular line onto outline U of building H. For example, in the case of using geographic center Z for specifying the distance of first and second person P from building H, third trajectory T3 would be determined in such a way that person P is moving towards building H. In the alternative method using a stored outline of building H, trajectory T2 of person P would be determined as running in parallel to outline U of building H. Accordingly, person P on second trajectory T2 would be moving, in accordance with this definition, neither towards building H nor away from it. The storing of outline U of building H as a structure, to which the distance of an object is to be recorded in the evaluation model, is thus able to increase the precision of the method of the present invention.

In a method step S04, a control signal is generated, based on a predetermined decision model as well as based on the determined position and/or the determined trajectory of first and second person P, P′. This may take place, for instance, using a control unit 18 of device 10 according to the present invention, see FIG. 3.

The decision model includes particularly decision rules which are used to generate the control signal based on the determined position and/or the trajectory of person P, P′.

According to the first specific embodiment, the control signal is generated if, according to the evaluation model, person P, P′ is moving towards building H. This is the case in the street scene shown in FIG. 2, for example, for third trajectory T3 and fourth trajectory T4. Additional decision rules of the decision model may be based on the determined position of person P, P′ in space region B″, for example. It may, for instance, be established that the control signal is generated only if person P, P′ is located in a predetermined partial space region B of space region B″ in the decision model and/or the evaluation model.

With reference to FIG. 2, in the decision model, the effective space region B″ may be subdivided into first space region B, to be monitored, and second space region B′. This subdivision may take place in coordinates referenced to radar receiving device 14. Alternatively, if an external coordinate system is specified in the evaluation model and/or the decision model, in which the position of radar receiving device 14 is noted, the subdivision of space region B″ into first partial space region B and second partial space region B′ may also take place in the external coordinates. In this case, it is of advantage if the determined first position and/or the trajectory of person P, P′ which are first calculated in the coordinates referenced to radar receiving device 14, are first recalculated into the external coordinates. The origin of the external coordinate system may advantageously be situated in geographic center Z of building H, or along circumference U of building H.

In the example of a street scene shown in FIG. 2, the first partial space region B, that is to be monitored, is established in such a way that it includes only positions belonging to property A1. Objects located in second partial space region B′, especially persons P′, do not lead to the generation S04 of a control signal. The first partial space region to be monitored may also be assigned to a door, a window, a fuse box or another region that is to be particularly precisely monitored.

Alternatively, it may be provided that objects, especially persons P′ in second partial space region B′, lead to the generating S04 of a control signal, if they are moving towards building H, for instance, along fourth trajectory T4, while objects, especially persons, in second partial space region B′, which(who) are not moving towards building H, do not lead to generating S04 of a control signal.

Furthermore, it may be provided that persons P, in first partial space region B, who are moving away from building H, for instance, along first trajectory T1, do not lead to generating S04 of the control signal, while persons P who are not moving, for instance, along second or third trajectory T2, T3, away from building H, do lead to generating S04 of the control signal.

In a step S05, an actuator device 20 is actuated, using the generated control signal, for monitoring space region B″. Actuator device 20 may be a part of the device 10 according to the present invention, or may be situated outside of it. Actuator device 20 may, for instance, be a lighting device for switching on an electric light, a window shutter device for opening, or closing window shutters and/or a camera device for picking up image data and/or sonic data. The image and/or sonic data may be stored automatically on a memory system, for example. Alternatively or in addition, a message of a part of image and/or audio data may be transmitted to a terminal, for instance, a mobile terminal such as a cell phone.

FIG. 3 shows a schematic block diagram of a device 10 for monitoring a space region B; B″, according to a second specific embodiment of the present invention.

Device 10 according to the second specific embodiment has radar sending device 12, that was discussed with reference to FIG. 2, radar receiving device 14, evaluation device 16, control unit 18 and actuator device 20. Furthermore, device 10 has an interface 22, using which the evaluation model of evaluation device 16 and/or the decision model of control unit 18 are adaptable. Interface 22 may be a radio interface, for example. Interface 22 may also, however, include an input and/or output device, for instance, a keyboard, a touchscreen, a microphone having a voice-processing unit, etc. Interface 22 may also be a cable-based interface, for instance, a serial interface, such as a USB interface or another type of data line.

Device 10 also has an energy source 24, which is developed to supply device 10 with electric power. The energy source 24 may, for instance, be an energy store, such as a battery, an energy generating unit, such as a fuel cell or a solar cell, or even an electrical connecting device for connecting device 10 to a power supply system.

Although the present invention was described above with reference to preferred exemplary embodiments, it is not limited to these, but may be modified in numerous ways. In particular, one is able to change or modify the invention in many ways without deviating from the crux of the present invention.

In place of building H, in relation to which the trajectory of the detected object was evaluated in the above exemplary embodiments for generating S04 of the control signal, any other object, terrain or position, that is worth protecting, may be substituted. For instance, as described above, the control signal may be generated or be able to be generated, as a function of a relative motion of the object relative to a window or a door, to an entrance way, to a protective fence, to a parking space, to a fastening system, to a manhole cover, etc.

In the decision model, decision rules may also be included, for example, which are based on a certain magnitude of the object in space region B, B″. In that way one is able to distinguish, for instance, between small animals and persons P, P′, using the method according to the present invention or the device, according to the present invention. If the object has a magnitude below a certain threshold value, for instance, less than one meter in each direction, no control signal is generated. Thereby, the probability may be reduced that the device, in a faulty manner, is identifying a small animal as a person, and, based on this, emits an undesired control signal.

Actuator device 20 may further be developed to simulate the presence of at least one person in building H, for instance, by suitable switching on and off electric lights in building H, by automatic opening or closing of window shutters or the like.

In the decision model, psychological points of view may also be taken into account, for instance, in the form of a pedestrian motion model included in the decision model, which describes with what probability a present trajectory of a person will change, in which manner, respectively in each case.

What is claimed is:

1. A method for monitoring an immobile space region, comprising:
emitting radar beams into the immobile space region by using a radar transmitting device fixedly installed with respect to the immobile space region;
receiving, by a radar receiving device fixedly installed with respect to the immobile space region, the emitted radar beams reflected in the immobile space region at an object;
evaluating, by an evaluation device, the received radar beams with the aid of a predetermined evaluation model for determining at least one of a first position and a trajectory of the object in the immobile space region;
generating, by a control unit, a control signal based on a predetermined decision model and at least one of the determined first position and the determined trajectory of the object; and
actuating an actuator device of the using the generated control signal.

2. The method as recited in claim 1, wherein:
at least one of the predetermined evaluation model and the predetermined decision model includes selected information on a second position of a structure with reference to the radar receiving device;
during the evaluation of the received radar beams, a first relative motion of the object is determined relative to the structure, based on the selected information; and
the control signal is generated further based on the determined first relative motion of the object relative to the structure.

3. The method as recited in claim 2, wherein:
during the evaluation of the received radar beams, a second relative motion of the object is determined relative to the radar receiving device; and
the control signal is generated further based on the determined second relative motion of the object relative to the radar receiving device.

4. The method as recited in claim 2, wherein:
during the evaluation of the received radar beams, a length of stay of the object in the space region is determined; and
the control signal is generated further based on the determined length of stay of the object.

5. A device for monitoring an immobile space region, comprising:
a radar transmitting device for emitting radar beams, said radar transmitting device being fixedly installed with regard to the immobile space region;
a radar receiving device fixedly installed with respect to the immobile space region for receiving the emitted radar beams which are reflected at an object in the immobile space region;
an evaluation device for evaluating the received radar beams by using a predetermined evaluation model for determining at least one of a first position and a trajectory of the object in the immobile space region;
a control unit for generating a control signal based on a predetermined decision model and at least one of the determined first position and the determined trajectory of the object; and
an actuator device controlled by the control signal generated by the control unit.

6. The device as recited in claim 5, wherein:
at least one of the predetermined evaluation model and the predetermined decision model includes information on a second position of a structure with reference to the radar receiving device;
the evaluation device is further configured to determine a first relative motion of the object relative to the structure, based on the information on the second position; and
the control unit is configured to generate the control signal further based on the determined first relative motion of the object relative to the structure.

7. The device as recited in claim 6, wherein:
the evaluation device is configured to further determine a second relative motion of the object relative to the radar receiving device; and
the control unit is configured to generate the control signal further based on the determined second relative motion of the object relative to the radar receiving device.

8. The device as recited in claim 6, wherein:
the evaluation device is configured to determine a length of stay of the object in the immobile space region; and
the control unit is configured to generate the control signal further based on the determined length of stay of the object in the immobile space region.

9. The device as recited in claim 6, further comprising:
a housing, wherein at least the radar transmitting device, the radar receiving device, the evaluation device, and the control unit are situated within the housing, and wherein the structure is an immobile structure, and wherein the housing is fixedly installed on the immobile structure with respect to the immobile space region.

10. The device as recited in claim 6, further comprising:
an interface, wherein at least one of the evaluation model of the evaluation device and the decision model of the control unit is adapted using the interface.
